(19) United States
(12) Patent Application Publication
(10) Pub. No.: US 2014/0312748 A1
(43) Pub. Date: Oct. 23, 2014

(54) ELECTRONIC DEVICE ENCLOSURE

(71) Applicant: HON HAI PRECISION INDUSTRY CO., LTD., New Taipei (TW)

(72) Inventor: CHEN-RUEI TU, New Taipei (TW)

(73) Assignee: HON HAI PRECISION INDUSTRY CO., LTD., New Taipei (TW)

(21) Appl. No.: 14/076,146

(22) Filed: Nov. 8, 2013

(30) Foreign Application Priority Data
Apr. 19, 2013 (TW) 102113918

(51) Int. Cl. G06F 1/18

(52) U.S. Cl. CPC G06F 1/181
USPC 312/223.1

(57) ABSTRACT

An electronic device enclosure includes a chassis, a securing member, and a bezel. The securing member is secured to a first side plate of the chassis. The bezel includes a pivot tab, and the pivot tab is engaged in the securing member via a through opening defined in a front panel of the securing member and engaged in a pivot hole of a pivot piece located on the front panel.

### BACKGROUND

1. Technical Field

The present disclosure relates to electronic device enclosures, and more particularly to an electronic device enclosures with a bezel.

2. Description of Related Art

In a server enclosure, a bezel is provided to decorate the server enclosure. Usually, the bezel is secured to a chassis of the server enclosure by a hinge member. A first part of the hinge member is fixed to the chassis by screws, and a second part of the hinge is also fixed to the bezel by screws. When the bezel is needed to be removed from the chassis, the hinge member should be removed from the chassis and the bezel at the same time, which is very inconvenient. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device enclosure in accordance with an embodiment.

FIG. 2 is an enlarged view of a circled portion II of FIG. 1.

FIG. 3 is an isometric view of a locking member of the electronic device enclosure of FIG. 1.

FIG. 4 is an exploded, isometric view of a bezel of the electronic device enclosure of FIG. 1.

FIG. 5 is an isometric, assembled, view of the enclosure device enclosure of FIG. 1.

FIG. 6 is an enlarged view of a circled portion VI of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

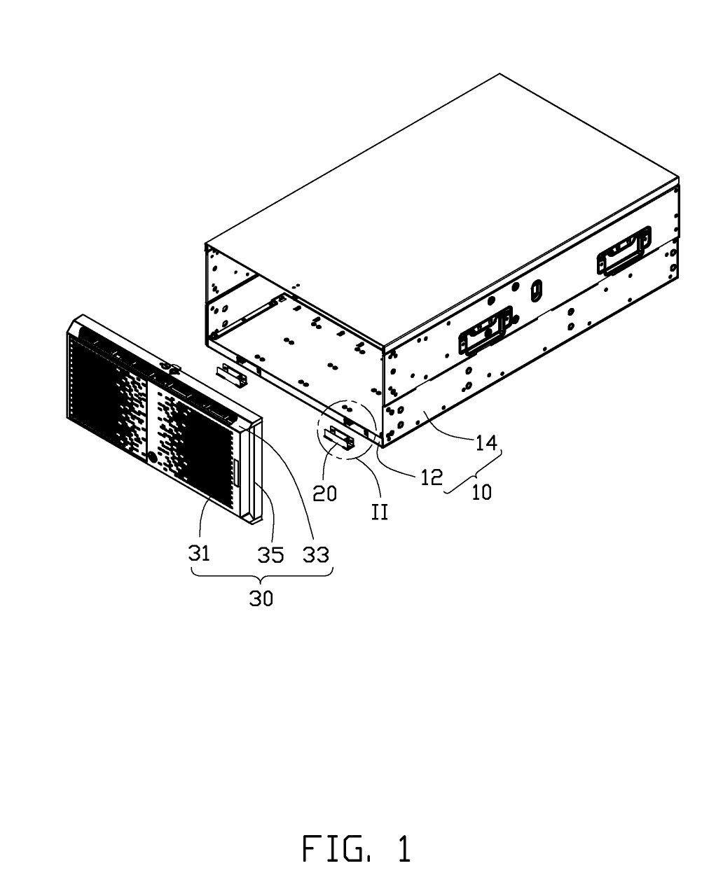

FIG. 1 is an electronic device enclosure in accordance with an embodiment. The electronic device enclosure comprises a chassis 10, two securing members 20, and a bezel 30. The electronic device enclosure may be a server enclosure, for example.

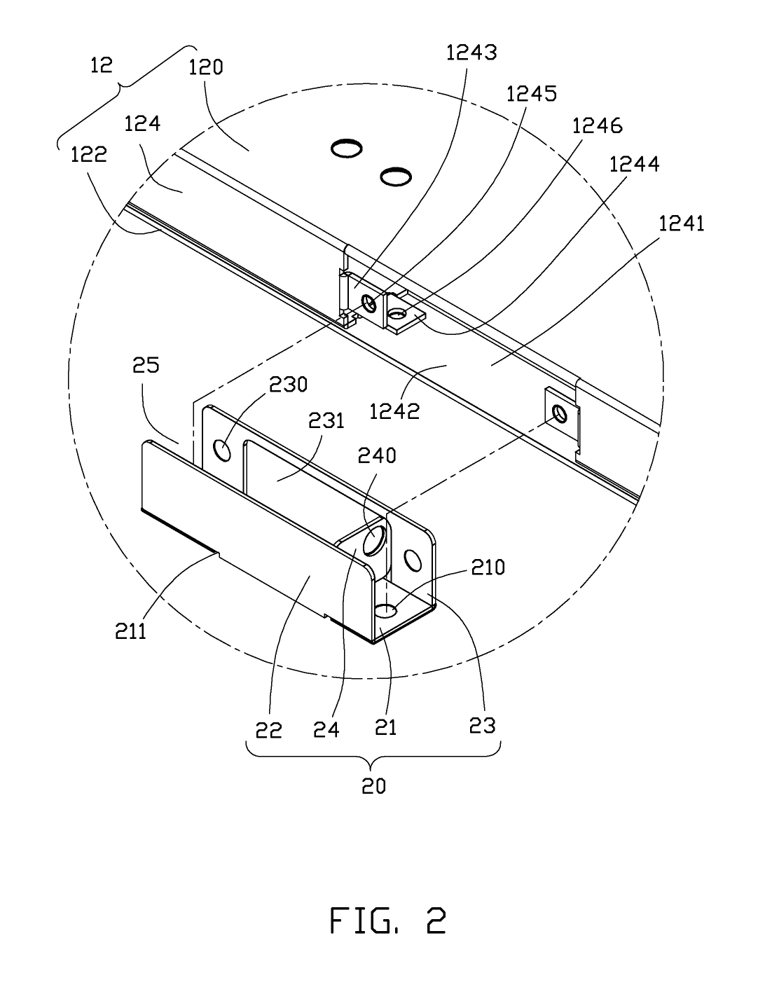

Referring to FIG. 1, the chassis 10 defines an accommodating space for receiving a plurality of electronic devices, such as circuit boards, disk drives, and expansion cards, for example. The chassis 10 comprises a first side plate 12 and a second side plate 14. The first side plate 12 is substantially perpendicular to the second side plate 14. FIG. 2 shows that the first side plate 12 comprises a first side panel 120, a second side panel 122 substantially parallel to the first side panel 120, and a front panel 124 connected to the first side panel 120 and the second side panel 122. The front panel 124 defines two through openings 1241. Two locking pieces 1243 extend from opposite edges of each of the two through openings 1241 towards each other. Each locking piece 1243 defines a locking hole 1245. The second side panel 122 defines two cutouts 1242, corresponding to the two through openings 1241. Two mounting pieces 1244 extend from opposite edges of each of the two cutouts 1242 towards each other. Each of the two mounting pieces 1244 defines a mounting hole 1246. The two mounting pieces 1244 are substantially perpendicular to the two locking pieces 1243.

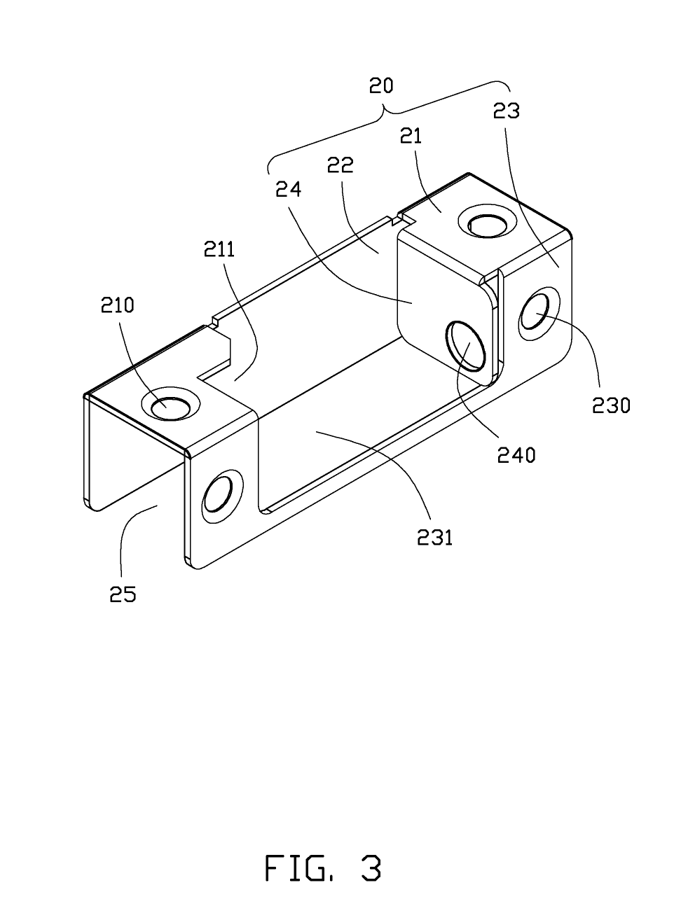

FIGS. 2 and 3 show that each of the two securing members 20 comprises a front wall 21, a first sidewall 22, a second sidewall 23, and a pivot piece 24. The front wall 21, the first sidewall 22, and the second sidewall 23 together define a securing space 25. The first sidewall 22 is substantially parallel to the second sidewall 23 and perpendicular to the front wall 21. The pivot piece 24 is located in the securing space 25 and substantially perpendicular to the front wall 21, the first sidewall 22, and the second sidewall 23. The front wall 21 defines a first receiving opening 211, and the second sidewall 23 defines a second receiving opening 231 communicating with the first receiving opening 211. The front sidewall 21 defines two first securing holes 210 located on two sides of the first receiving opening 211. The second sidewall 23 defines two second securing holes 230 located on two sides of the second receiving opening 231. The pivot piece 24 defines a pivot hole 240. In an embodiment, the pivot piece 24 extends from an edge of the first receiving opening 211.

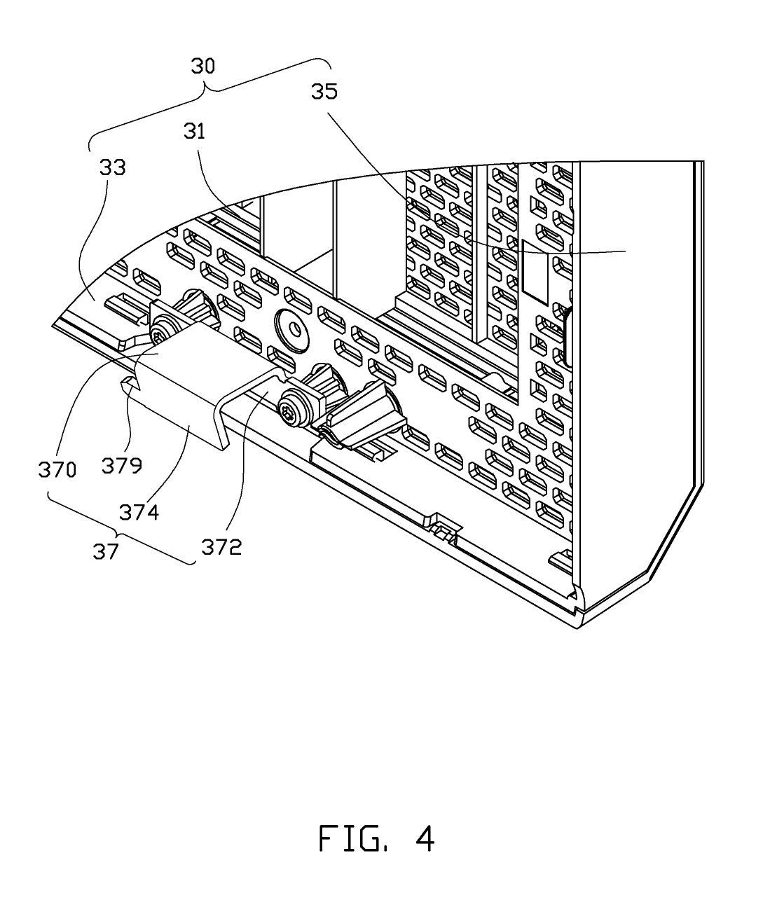

FIGS. 1 and 4 show that the bezel 30 comprises a bezel body 31, two first side flanges 33 extending from opposite long edges of the bezel body 31, two second side flanges 35 extending from opposite short edges of the bezel body 31, and two installation members 37 located on one of the two first side flanges 33. The two first side flanges 33 are substantially perpendicular to the two second side flanges 35. Each of the two installation members 37 comprises a base piece 370, an installation piece 372, and an extension piece 374. The installation piece 372 and the extension piece 374 extend from opposite edges of the base piece 370. The installation piece 372 is located on the first side flange 33. In an embodiment, the installation piece 372 is fixed to the first side flange 33 by two fasteners, such as screws, or extends from the first side flange 33. The extension piece 374 is substantially parallel to the installation piece 372 and perpendicular to the base piece 370. A pivot tab 379 extends from a side edge of the extension piece 374.

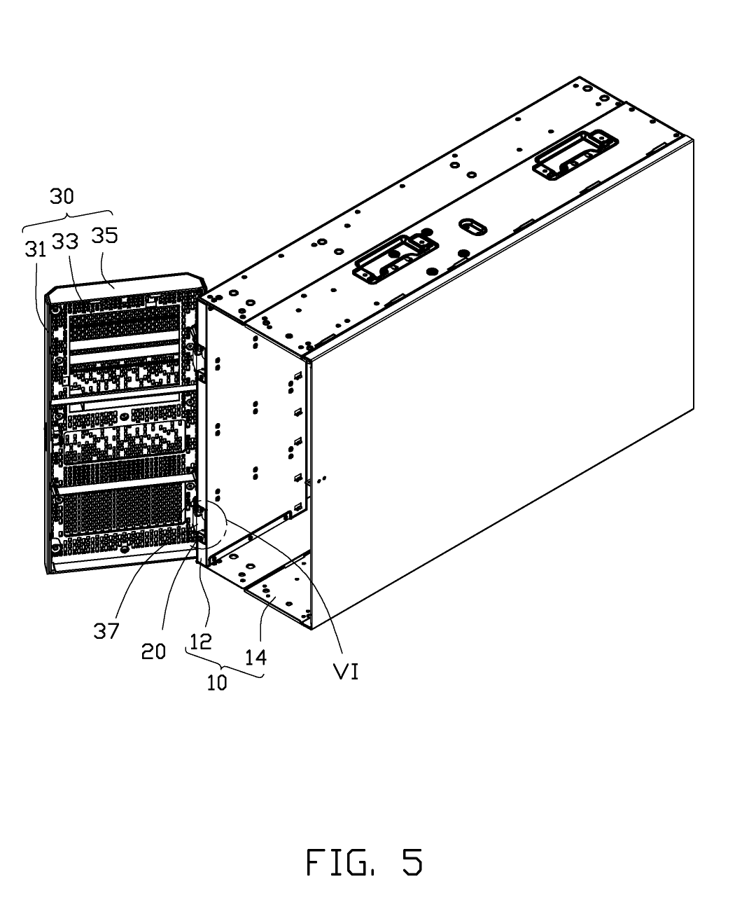

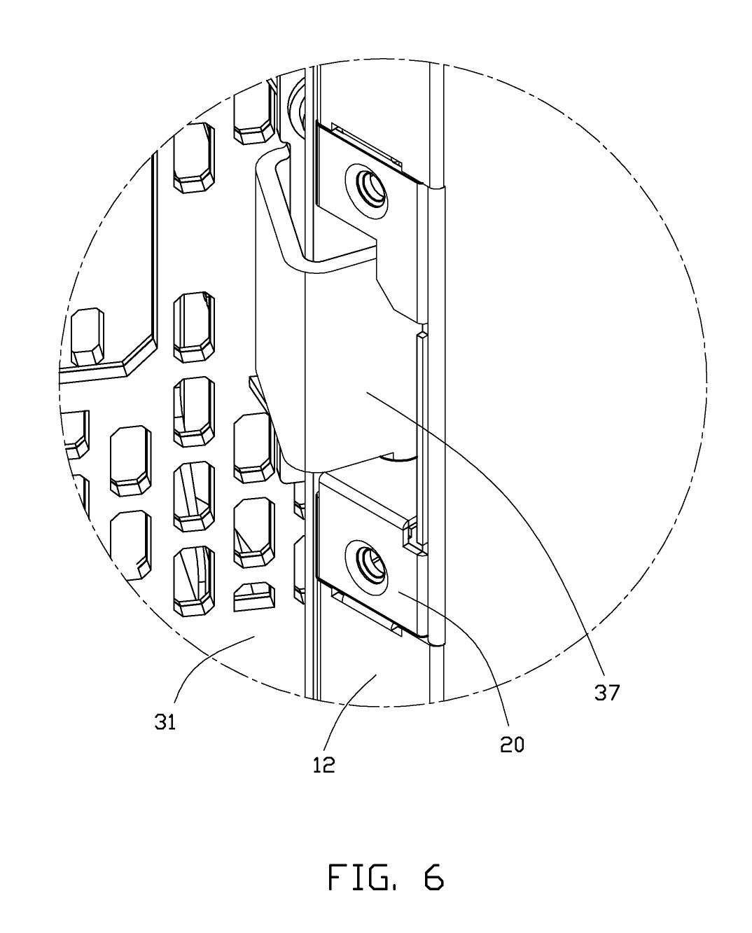

FIGS. 4 to 6 show that in assembly, each of the two securing members 20 is received in each of the two through openings 1241. The two locking pieces 1243 are received in the securing space 25, and the two first securing holes 210 are aligned with the locking holes 1245. Two first fixing members, such as screws, are fixed in the two first securing holes 210 and the locking holes 1245, to secure the front wall 21 to the front panel 124. The two second securing holes 230 are aligned with the mounting holes 1246 of the two mounting pieces 1244. Two second fixing members, such as screws, are fixed in the two securing holes 230 and the mounting holes 1246, to secure the second sidewall 23 of each of the two securing members 20 to the second side panel 122. Therefore, the two securing members 20 are secured to the chassis 10. The pivot pieces 24 are substantially perpendicular to the front panel 124, the first side panel 120, and the second panel 122. The first sidewall 22 is substantially parallel to the first side panel 120. The front wall 21 is substantially parallel to the front panel 124. The extension pieces 374 of two installation members 37 are inserted into the securing spaces 25 of the two securing members 20 via the first receiving opening 211. The pivot tabs 379 are engaged in the pivot holes 240 of the two securing member 20. Thus, the bezel 30 is pivotably secured to the chassis 10.

When the bezel 30 needs to be removed from the chassis 10, the bezel 30 is moved to be disengaged from the pivot tabs 379 of the two installation members 37 from the pivot holes 240 of the two securing member 20. The bezel 30 then can be easily removed from the chassis 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An electronic device enclosure, comprising:
a chassis comprising a first side plate; the first side plate comprising a first side panel, a second side panel, and a front panel connected to the first side panel and the second side panel; and the front panel defining a through opening;
a securing member secured to the first side plate in the through opening; the securing member comprising a front wall secured to the first side plate and a pivot piece located on an inner surface of the front wall, the front wall covering the through opening and defining a first receiving opening, and the pivot piece defining a pivot hole; and
a bezel comprising a first side flange, an installation member located on the first side flange, the installation member comprising a pivot tab, and the pivot tab is inserted in the first receiving opening and detachably engaged in the pivot hole, to pivotably secure the bezel to the first side plate.

2. The electronic device enclosure of claim 1, wherein two locking pieces extends from opposite edges from the through opening of the front panel, each of the two locking pieces defines a locking hole, the front wall defines two first securing holes aligned with the locking holes of the two locking pieces, and two first fasteners are engaged in the two first securing holes and the locking holes to secure the front wall to the front panel.

3. The electronic device enclosure of claim 1, wherein the second side panel defines a cutout, two mounting pieces extend from opposite edges of the cutout, each of the two mounting pieces defines a mounting hole, the securing member further comprises a second sidewall, the second sidewall defines two second securing holes aligned with the mounting holes of the two mounting pieces, and two second fasteners are engaged in the two second securing holes and the mounting holes to secure the second sidewall to the second side panel.

4. The electronic device enclosure of claim 3, wherein the securing member further comprises a first sidewall, the first sidewall is substantially parallel to the second sidewall and perpendicular to the front wall, the front wall connected to the first sidewall and the second sidewall, and the pivot piece is substantially perpendicular to the front wall and the first sidewall.

5. The electronic device enclosure of claim 3, wherein the second sidewall defines a second receiving opening communicating with the first receiving opening.

6. The electronic device enclosure of claim 1, wherein the first side panel is substantially parallel to the second side panel, and the front panel is substantially perpendicular to the first side panel.

7. The electronic device enclosure of claim 1, wherein the installation member comprises a base piece, an installation piece and an extension piece; the base piece connected to the installation piece and the extension piece; and the installation piece is secured to the first side flange, and the pivot tab extends from the extension piece.

8. An electronic device enclosure, comprising:
a chassis comprising a first side plate; the first side plate comprising a first side panel, and a second side panel parallel to the first side panel;
a securing member located between the first side panel and the second side panel;
the securing member comprising a front wall secured to the first side plate and a pivot piece located on an inner surface of the front wall, the front wall being substantially perpendicular to the first side panel and defining a first receiving opening; and the pivot piece defining a pivot hole; and
a bezel comprising a first side flange, an installation member located on the first side flange, the installation member comprising a pivot tab, and the pivot tab is inserted in the first receiving opening and detachably engaged in the pivot hole, to pivotably secure the bezel to the first side plate.

9. The electronic device enclosure of claim 8, wherein the first side plate further comprises a front panel, the front panel defining a through opening, two locking pieces extends from opposite edges from the through opening of the front panel, each of the two locking pieces defines a locking hole, the front wall defines two first securing holes aligned with the locking holes of the two locking pieces, and two first fasteners are engaged in the two first securing holes and the locking holes to secure the front wall to the front panel.

10. The electronic device enclosure of claim 9, wherein the front panel is substantially perpendicular to the first side panel.

11. The electronic device enclosure of claim 8, wherein the second side panel defines a cutout, two mounting pieces extend from opposite edges of the cutout, each of the two mounting pieces defines a mounting hole, the securing member further comprises a second sidewall, the second sidewall defines two second securing holes aligned with the mounting holes of the two mounting pieces, and two second fasteners are engaged in the two second securing holes and the mounting holes to secure the second sidewall to the second side panel.

12. The electronic device enclosure of claim 11, wherein the securing member further comprises a first sidewall, the first sidewall is substantially parallel to the second sidewall and perpendicular to the front wall, the front wall connected to the first sidewall and the second sidewall, and the pivot piece is substantially perpendicular to the front wall and the first sidewall.

13. The electronic device enclosure of claim 11, wherein the second sidewall defines a second receiving opening communicating with the first receiving opening.

14. The electronic device enclosure of claim 8, wherein the installation member comprises a base piece, an installation piece and an extension piece; the base piece connected to the installation piece and the extension piece; the installation piece is secured to the first side flange, and the pivot tab extends from the extension piece.
